(19) United States
(12) Patent Application Publication
(10) Pub. No.: US 2024/0336193 A1
(43) Pub. Date: Oct. 10, 2024

(54) PERSONALIZED DRIVING EARLY WARNING METHOD AND PERSONALIZED DRIVING EARLY WARNING SYSTEM

(71) Applicant: MiTac Digital Technology Corporation, Taoyuan City (TW)

(72) Inventor: Jui-Ying Chung, Taoyuan City (TW)

(73) Assignee: MiTac Digital Technology Corporation, Taoyuan City (TW)

(21) Appl. No.: 18/626,501

(22) Filed: Apr. 4, 2024

(30) Foreign Application Priority Data
Apr. 7, 2023 (TW) 112113037

(51) Int. Cl. B60Q 9/00

(52) U.S. Cl. CPC B60Q 9/008

(57) ABSTRACT

A personalized driving early warning method is provided for use by a vehicle. When a specific dangerous event is detected, a computer system of the vehicle detects a facial expression or a behavior of a driver and determines whether it conforms to a predefined positive behavior or a predefined negative behavior. Based on a historical behavioral performance record of the driver and the detected facial expression or behavior, the computer system determines a subsequent action that is aligned with a current behavior the driver. The action is controlling a warning module of the vehicle not to issue any immediate warning output, or to issue an immediate warning output for notifying the driver of the specific dangerous event.

### CROSS-REFERENCE TO RELATED APPLICATION

This application claims priority to Taiwanese Invention Patent Application No. 112113037, filed on Apr. 7, 2023, and incorporated by reference herein in its entirety.

### FIELD

The disclosure relates to a vehicle warning method and system, and more particularly to a personalized driving early warning method and system.

### BACKGROUND

Safety assistance systems in vehicles have evolved from camera monitor systems (CMSs) to advanced driver assistance systems (ADASs), and from driver monitoring systems (DMSs) to in-cabin monitoring systems (ICMSs). Due to intense competition among major automakers in terms of vehicle safety assistance features, these systems have gradually become standard features with auto industry certifications. In particular, all European Union member countries have mandated that new vehicles sold from July 2022 onwards must be equipped with DMSs. As a result, drivers of vehicles with various safety assistance systems need to invest a significant amount of time familiarizing themselves with operation of these systems and understanding their warning functions before hitting the road, otherwise the drivers may not effectively utilize these safety assistance systems and/or comprehend the meaning behind various warnings. For older or less-experienced drivers, excessive warnings during driving may be a burden to the driver's mental state, resulting in nervousness or warning fatigue. For experienced drivers, unnecessary warning sounds may become a source of noise pollution, causing uneasiness.

### SUMMARY

Therefore, a personalized driving early warning system that is adapted for drivers with varying levels of experience, ages, and driving habits is a goal in the industry to ensure both a comfortable driving experience and road safety.

An object of the disclosure is to provide a personalized driving early warning method and system that can alleviate at least one of the drawbacks of the prior art.

According to the disclosure, the personalized driving early warning method is provided to be implemented by a computer system that is installed in a vehicle and that is electrically connected to an event data recorder and a driver monitoring recorder of the vehicle. The personalized driving early warning method includes steps of: A) by an event detection module of the computer system, detecting, based on a driving footage captured by the event data recorder, whether there is currently a specific dangerous event in a state of motion of the vehicle; B) by a behavior determination module of the computer system, identifying, based on an in-vehicle driver monitoring footage captured by the driver monitoring recorder, one of a facial expression feature and a behavioral feature of a driver of the vehicle when the event detection module has detected that there is currently the specific dangerous event in the state of motion of the vehicle; C) by the behavior determination module, after obtaining a behavior identification result by successfully identifying said one of the facial expression feature and the behavioral feature of the driver in step B), determining whether the behavior identification result conforms to a predefined positive behavior or a predefined negative behavior in terms of driving safety, so as to obtain a behavior determination result; and D) by a processing module of the computer system, based on the behavior determination result and a historical behavioral performance record of the driver that is stored in a storage module of the computer system, controlling a warning module of the computer system to perform one of a first action and a second action that is aligned with an up-to-date behavioral pattern of the driver, where the first action is that the warning module does not issue any immediate warning output, and the second action is that the warning module issues an immediate warning output to notify the driver of the specific dangerous event.

According to the disclosure, the personalized driving early warning system is to be installed in a vehicle for use with an event data recorder and a driver monitoring recorder, and includes a storage module, an event detection module, a behavior determination module, a warning module and a processing module. The storage module stores a historical behavioral performance record of a driver of the vehicle. The event detection module is configured to determine, based on a driving footage captured by the event data recorder, whether there is currently a specific dangerous event in a state of motion of the vehicle, and to generate an event notification upon determining that there is currently the specific dangerous event in the state of motion of the vehicle. The behavior determination module is coupled to the event detection module for receiving the event notification, is configured to, in response to the event notification, identify one of a facial expression feature and a behavioral feature of the driver based on an in-vehicle driver monitoring footage captured by the driver monitoring recorder, and is further configured to, after obtaining a behavior identification result by successfully identifying the one of the facial expression feature and the behavioral feature of the driver, determine whether the behavior identification result conforms to a predefined positive behavior or a predefined negative behavior in terms of driving safety, so as to obtain a behavior determination result. The warning module is operable to issue an immediate warning output in one of multiple manners that correspond to different levels of warning effects, respectively. The processing module is electrically connected to the storage module, the event detection module, the behavior determination module and the warning module, and is configured to control operation of the warning module based on the behavior determination result and the historical behavioral performance record to make the warning module perform one of a first action and a second action that is aligned with an up-to-date behavior pattern of the driver. The first action is that the warning module does not issue any immediate warning output, and the second action is that the warning module issues the immediate warning output to notify the driver of the specific dangerous event.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an embodiment of a personalized driving early warning system according to the disclosure.

FIG. 2 is a flow chart illustrating an embodiment of a personalized driving early warning method according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

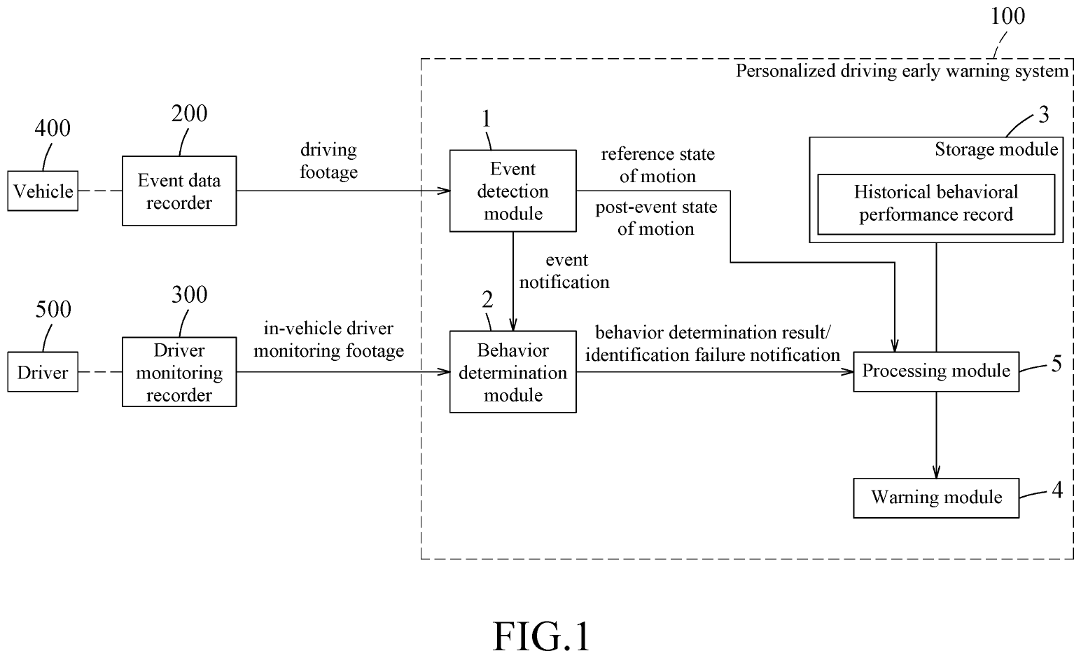

Referring to FIG. 1, an embodiment of a personalized driving early warning system 100 according to this disclosure is adapted for use with an event data recorder 200 and a driver monitoring recorder 300. In this embodiment, the personalized driving early warning system 100, the event data recorder 200 and the driver monitoring recorder 300 are all installed on a vehicle 400. The event data recorder 200 includes an image capturing device, which may be realized by, for example, one or more charge-coupled devices (CCDs), to capture images of an external environment of the vehicle 400. The driver monitoring recorder 300 includes an image capturing device, which may be realized by, for example, one or more CCDs, to capture images of a driver 500 within the vehicle 400. In this embodiment, the personalized driving early warning system 100 is a computer system that includes an event detection module 1, a behavior determination module 2, a storage module 3, a warning module 4, and a processing module 5.

The storage module 3 is configured to store a historical behavioral performance record of the driver 500, and may be realized as a non-transitory storage medium, such as a flash memory module, a hard disk drive, a solid state drive, etc., and this disclosure is not limited in this respect. In one example, the historical behavioral performance record documents, for every predefined dangerous event (e.g., lane departure incidents, tailgating, etc.) that was detected by the personalized driving early warning system 100 in the past, a (past) behavioral performance of the driver 500 in response to the detected event, where a record of the behavioral performance thus documented may contain a time instant when the event was detected, and an evaluation of the behavioral performance of the driver 500 (e.g., being a positive performance or a negative performance). Accordingly, for each predefined dangerous event, a number of instances of positive performance by the driver 500 when the driver 500 encountered the predefined dangerous event as well as a number of instances of negative performance by the driver 500 when the driver 500 encountered the predefined dangerous event can be found in the historical behavioral performance record.

The event detection module 1 is coupled to the event data recorder 200 for receiving one or more driving footages (e.g., footages from front, rear, and/or sides of the vehicle 400) captured by the event data recorder 200, and is configured to detect whether there is currently one of multiple predefined dangerous events (referred to as “specific dangerous event” hereinafter) in a state of motion of the vehicle 400 based on at least one of the driving footages. In one embodiment, the event detection module 1 may be realized using existing ADAS technologies such as lane departure detection and forward collision detection to achieve the detection of the specific dangerous event (e.g., lane departure incidents, tailgating, etc.). In addition, the event detection module 1 may acquire the state of motion of the vehicle 400 based on speed, angular speed and angular acceleration of the vehicle 400 sensed by an acceleration sensor, a gyroscope, and/or a global positioning system (GPS) module included in the event data recorder 200. In some embodiments, the event detection module 1 may be realized as program codes to be executed by a processor. In one embodiment, the vehicle 400 may include an ADAS that integrates the event detection module 1 and the event data recorder 200 together.

The behavior determination module 2 is coupled to the driver monitoring recorder 300 for receiving an in-vehicle driver monitoring footage captured by the driver monitoring recorder 300, and is configured to identify, based on the in-vehicle driver monitoring footage, a facial expression feature and/or a behavioral feature (e.g., relating to hands and/or an upper body) of the driver 500 when the event detection module 1 has detected that there is currently the specific dangerous event in the state of motion of the vehicle 400, so as to obtain a behavior identification result when successfully identifying the facial expression feature and/or the behavioral feature of the driver 500. In practice, the behavior determination module 2 may utilize identification techniques that have been widely used in DMSs to obtain the behavior determination result. In one example, the identification techniques may be related to eye features for identifying eye gaze direction, signs of drowsiness, eye closure, and/or other eye-related behaviors. In one example, the identification techniques may be related to mouth features for identifying yawning and/or other mouth-related behaviors. In one example, the identification techniques may be related to head features for identifying nodding, tilting of the head, and/or other head-related behaviors. In one example, the identification techniques may be related to hand features for identifying position of hands and/or other hand-related behaviors. With these techniques, the behavior determination module 2 is able to identify the behavior of the driver 500, so as to obtain the behavior identification result. In practice, contrary to changes in behavior, which typically involve a series of actions and therefore take more time, changes in some facial expressions are transient and rapid, such as but not limited to, the driver 500 zoning out all of a sudden or feeling drowsy for just a brief moment in between periods of being alert. Therefore, in order to accurately determine a mental state of the driver 500 at the moment the specific dangerous event is detected, assessing the facial expression feature is prioritized over assessing the behavioral feature. It is noted that the assessment of the facial expression feature is not limited to the moment when the specific dangerous event is detected, and may encompass a brief period of time (e.g., 3 seconds) traced back from the moment when the specific dangerous event is detected. Therefore, in some embodiments, the behavior determination module 2 identifies, based on the in-vehicle driver monitoring footage, the facial expression feature of the driver 500 as the first priority immediately after the event detection module 1 has detected that there is currently the specific dangerous event in the state of motion of the vehicle 400. Then, following the identifying of the facial expression feature of the driver 500, the behavior determination module 2 identifies the behavioral feature based on the in-vehicle driver monitoring footage. After obtaining the behavior identification result, the behavior determination module 2 determines, based on a referential behavioral feature dataset that is related to facial expressions and driver behaviors, whether the behavior identification result conforms to a predefined positive behavior or a predefined negative behavior in terms of driving safety, so as to obtain a behavior determination result. In this embodiment, the referential behavioral feature dataset may be built or stored in the behavior determination module 2, and contains multiple predefined positive behaviors and multiple predefined negative behaviors that are related to driving safety. The predefined positive behaviors may include, for example but not limited to, both eyes looking straight ahead, both hands resting on or gripping a steering wheel, etc. In this embodiment, some of the predefined negative behaviors are categorized as low-risk negative behaviors, such as but not limited to, eyes not looking straight ahead, signs of eye fatigue, yawning, nodding, tilting of the head, etc., and some of the predefined negative behaviors are categorized as high-risk negative behaviors, such as but not limited to, reaching for objects, using a mobile phone, etc. In some embodiments, the criteria for assessing the predefined positive behaviors and the predefined negative behaviors may vary from person to person. As an example, the act of yawning may be classified into a single yawn or a series of consecutive yawns, and the single yawn may be defined as a negative behavior for some people, but not for others. For different drivers, the corresponding positive and negative behaviors may be determined based on individual hand and head movements and facial expressions. In some embodiments, the behavior determination module 2 may be realized as program codes to be executed by a processor. In one embodiment, the vehicle 400 may include a DMS that integrates the behavior determination module 2 and the driver monitoring recorder 300 together.

The warning module 4 is operable to issue a warning output in one of multiple different manners that correspond to different levels of warning effects, respectively. For example, the warning module 4 may include a buzzer for outputting a monotone alarm sound, a speaker for delivering verbal warning messages, and a display screen for showing warning symbols, warning text, and/or warning images. In some embodiments, the vehicle 400 may include a center console that is equipped with the monotone alarm buzzer, the speaker and the display screen to realize the warning module 4. In this embodiment, the warning module 4 may issue the warning output in one of a plurality of predefined warning types, which include a standard warning (e.g., outputting only a verbal warning message), a diminished warning that has a warning effect weaker than a warning effect of the standard warning (e.g., outputting only the monotone alarm sound), and an enhanced warning that has a warning effect stronger than the warning effect of the standard warning. In this embodiment, the enhanced warning may be a highest level warning (e.g., outputting the monotone alarm sound, the verbal warning message, the warning symbols, and the warning images) or a second-highest level warning (e.g., outputting the monotone alarm sound, the verbal warning message, and the warning symbols), where the highest level warning has a warning effect stronger than a warning effect of the second-highest level warning. However, this disclosure is not limited in this respect.

The processing module 5 is coupled to the event detection module 1, the behavior determination module 2, the storage module 3 and the warning module 4, and is configured to control operation of the warning module 4 based on the behavior determination result received from the behavior determination module 2 and the historical behavioral performance record received from the storage module 3, so that an action performed by the warning module 4 is aligned with an up-to-date behavioral pattern of the driver 500, where the action may be that the warning module 4 does not issue any immediate warning output (namely, not providing any notification or alert to the driver 500), or that the warning module 4 issues an immediate warning output to notify the driver 500 of the specific dangerous event. In some embodiments, the historical behavioral performance record not only documents facial expressions and/or body reactions of the driver 500 at the moment the specific dangerous event was detected, but also records subsequent handling/driving of the vehicle 400, which may serve as a basis for determining whether the facial expressions and/or body reactions are positive behaviors or negative behaviors in the future. For example, when a facial expression that belongs to a predefined negative behavior was detected at the moment the specific dangerous event occurred but the following driving was steady, and such condition repeatedly occurred for several times, the processing module 5 may adjust the criteria for assessing the predefined positive behaviors and the predefined negative behaviors for the driver 500, such that the facial expression is no longer a predefined negative behavior for the driver 500. In some embodiments, the processing module 5 may be realized using a processor that is coupled to an ADAS and a DMS that implement the event detection module 1 and the behavior determination module 2, respectively. In practice, the event detection module 1, the behavior determination module 2 and the processing module 5 may be integrated into either the same processor or different processors, and this disclosure is not limited in this respect.

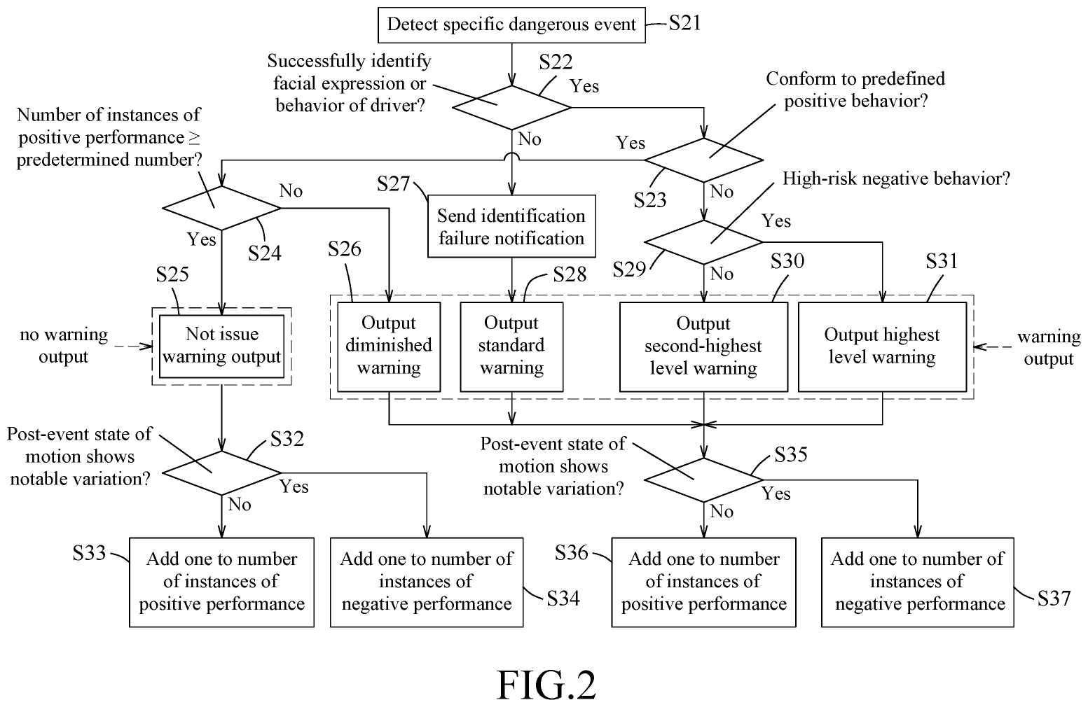

FIG. 2 is a flow chart that cooperates with FIG. 1 to illustrate an embodiment of a personalized driving early warning method that is adapted for the driver 500 according to this disclosure. The personalized driving early warning method is implemented by the personalized driving early warning system 100 during travelling of the vehicle 400.

In step S21, upon determining that there is currently the specific dangerous event in the state of motion of the vehicle 400 from the driving footage captured by the event data recorder 200, the event detection module 1 generates and sends an event notification to the behavior determination module 2, and sends data that correspond to the state of motion of the vehicle 400 when the specific dangerous event was detected (referred to as reference state of motion hereinafter) to the processing module 5.

In step S22, in response to the event notification, the behavior determination module 2 identifies facial expression feature(s) and/or behavioral feature(s) of the driver 500 based on the in-vehicle driver monitoring footage captured by the driver monitoring recorder 300. When the behavior determination module 2 successfully identifies one or more facial expression features and/or the behavioral features of the driver 500 and obtains a behavior identification result, the flow goes to step S23. When the behavior determination module 2 fails to identify any facial expression feature or behavioral feature of the driver 500, the flow goes to step S27.

In step S23, the behavior determination module 2 determines whether the behavior identification result (i.e., the identified facial expression feature(s) and/or behavior feature(s)) conforms to a predefined positive behavior or a predefined negative behavior in terms of driving safety, so as to obtain and send a behavior determination result to the processing module 5. When the behavior determination module 2 determines that the behavior identification result conforms to one of the predefined positive behaviors, the flow goes to step S24. When the behavior determination module 2 determines that the behavior identification result conforms to one of the predefined negative behaviors, the flow goes to step S29.

In step S24, the processing module 5 determines whether the number of instances of positive performance that corresponds to the specific dangerous event is not smaller than a predetermined number (e.g., three times). The flow goes to step S25 when the determination is affirmative (i.e., the number of instances of positive performance that corresponds to the specific dangerous event is not smaller than the predetermined number), and goes to step S26 when otherwise.

In step S25, the processing module 5 controls the warning module 4 to not issue any immediate warning output.

In step S26, the processing module 5 controls the warning module 4 to output the diminished warning serving as the immediate warning output.

In step S27, the event detection module 1 sends an identification failure notification to the processing module 5.

In step S28, in response to the identification failure notification, the processing module 5 controls the warning module 4 to output the standard warning serving as the immediate warning output.

In step S29, the processing module 5 determines whether the predefined negative behavior the behavior identification result conforms to is categorized as a high-risk negative behavior or a low-risk negative behavior. When determining that the predefined negative behavior is categorized as a high-risk negative behavior, the flow goes to step S31. Otherwise, the flow goes to step S30.

In step S30, the processing module 5 controls the warning module 4 to output the second-highest level warning serving as the immediate warning output.

In step S31, the processing module 5 controls the warning module 4 to output the highest level warning serving as the immediate warning output.

After step S25, S26, S28, S30 or S31, the event detection module 1 sends, to the processing module 5, data of post-event state of motion of the vehicle 400 that occurs within a predefined time period after the step, and the flow goes to step S32 or S35 in order to determine whether the action performed in step S25, S26, S28, S30 or S31 by the personalized driving early warning system 100 was appropriate or necessary for the driver 500, and to verify a following performance of the driver 500 in response to the action performed in step S25, S26, S28, S30 or S31 by the personalized driving early warning system 100.

In step S32 that follows step S25, the processing module 5 determines whether the post-event state of motion of the vehicle 400 shows a notable change (e.g., a plunge in speed or a surge in acceleration or angular acceleration that may be caused by a collision) or correction (e.g., gradual decrease in speed or adjustments in a travelling direction) relative to the reference state of motion of the vehicle 400 (i.e., the state of motion of the vehicle 400 when the specific dangerous event was detected). When the post-event state of motion shows a variation that is not greater than a predetermined level relative to the reference state of motion (e.g., a change in acceleration is not greater than a predefined value such as 0.2 G, or a change in the travelling direction having a correction angle of not exceeding a predetermined value such as 20 degrees), the processing module 5 determines that the action performed by the personalized driving early warning system 100 in step S25 (i.e., controlling the warning module 4 to not issue any immediate warning output) was appropriate for the driver 500 because the driver 500 seems to be in a state of alertness sufficient to react to changes in external road conditions in time, and the flow goes to step S33. When the post-event state of motion shows a variation that is greater than the predetermined level relative to the reference state of motion, the processing module 5 determines that the action performed by the personalized driving early warning system 100 in step S25 was inappropriate for the driver 500 because the driver 500 seems to be inattentive and unlikely to manage the vehicle 400 smoothly in response to changes in external road conditions, and the flow goes to step S34.

In step S33, the processing module 5 updates the historical behavioral performance record by adding one to the number of instances of positive performance and recording a corresponding time instant when the specific event was detected.

In step S34, the processing module 5 updates the historical behavioral performance record by adding one to the number of instances of negative performance and recording a corresponding time instant when the specific event was detected.

In step S35 that follows each of steps S26, S28, S30 and S31, the processing module 5 determines whether the post-event state of motion of the vehicle 400 shows a notable change or correction relative to the reference state of motion of the vehicle 400 by determining whether the post-event state of motion shows a variation that is greater than the predetermined level relative to the reference state of motion. When the variation is not greater than the predetermined level, the processing module 5 determines that the issuance of the immediate warning output in step S26, S28, S30 or S31 was unnecessary for the driver 500 because the driver 500 seems to be focused on driving, and the flow goes to step S36. When the variation is greater than the predetermined level relative to the reference state of motion, the processing module 5 determines that the issuance of the immediate warning output in step S26, S28, S30 or S31 was necessary for the driver 500 because the driver 500 seems to be inattentive, and the flow goes to step S37.

In step S36, the processing module 5 updates the historical behavioral performance record by adding one to the number of instances of positive performance and recording a corresponding time instant when the specific event was detected.

In step S37, the processing module 5 updates the historical behavioral performance record by adding one to the number of instances of negative performance and recording a corresponding time instant when the specific event was detected.

In some embodiments, the historical behavioral performance record updated in step S33, S34, S36 or S37 can be fed back to the behavior determination module 2 for the behavior determination module 2 to modify the referential behavioral feature dataset that is used to determine whether the behavior identification result conforms to a predefined positive behavior or a predefined negative behavior, so that the behavior determination result is personalized to fully reflect the behavioral pattern of the driver 500.

In summary, every time the event detection module 1 detects one of the predefined dangerous events, the personalized driving early warning method will be executed to determine whether or not to issue an immediate warning output and, in the affirmative, which type of immediate warning output should be issued based on the historical behavioral performance record that corresponds to the driver 500. Furthermore, the processing module 5 can verify whether the action thus taken was appropriate or necessary for the driver 500 based on the post-event state of motion of the vehicle 400, and update the historical behavioral performance record accordingly, so that the behavior determination module 2 can adapt the referential behavioral feature dataset using the continuously updated historical behavioral performance record to fully reflect the behavioral pattern of the driver 500, and can thus assess the behavior identification result more accurately. By virtue of such configuration, the personalized driving early warning system 100 reduces a probability of misjudging driver's behaviors due to individual differences among drivers to ensure a comfortable driving experience for drivers who tend to focus on driving, while providing personalized driving alerts for drivers prone to being inattentive during driving to ensure road safety.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A personalized driving early warning method implemented by a computer system that is installed in a vehicle and that is electrically connected to an event data recorder and a driver monitoring recorder of the vehicle, said personalized driving early warning method comprising steps of:
A) by an event detection module of the computer system, detecting, based on a driving footage captured by the event data recorder, whether there is currently a specific dangerous event in a state of motion of the vehicle;
B) by a behavior determination module of the computer system, identifying, based on an in-vehicle driver monitoring footage captured by the driver monitoring recorder, one of a facial expression feature and a behavioral feature of a driver of the vehicle when the event detection module has detected that there is currently the specific dangerous event in the state of motion of the vehicle;
C) by the behavior determination module, after obtaining a behavior identification result by successfully identifying said one of the facial expression feature and the behavioral feature of the driver in step B), determining whether the behavior identification result conforms to a predefined positive behavior or a predefined negative behavior in terms of driving safety, so as to obtain a behavior determination result; and
D) by a processing module of the computer system, based on the behavior determination result and a historical behavioral performance record of the driver that is stored in a storage module of the computer system, controlling a warning module of the computer system to perform one of a first action and a second action that is aligned with an up-to-date behavioral pattern of the driver, where the first action is that the warning module does not issue any immediate warning output, and the second action is that the warning module issues an immediate warning output to notify the driver of the specific dangerous event.

2. The personalized driving early warning method as claimed in claim 1, wherein the historical behavioral performance record records a number of instances of positive performance by the driver when the driver encountered the specific dangerous event in the past;
wherein the immediate warning output is in one of a plurality of predefined warning types, and the predefined warning types include a standard warning, an enhanced warning that has a warning effect stronger than a warning effect of the standard warning, and a diminished warning that has a warning effect weaker than the warning effect of the standard warning; and
wherein step D) includes sub-steps of:
D-1) by the processing module, when the behavior determination result indicates that the behavior identification result conforms to the predefined negative behavior, controlling the warning module to output the enhanced warning that serves as the immediate warning output; and
D-2) by the processing module, when the behavior determination result indicates that the behavior identification result conforms to the predefined positive behavior, controlling, based on the number of instances of positive performance as recorded in the historical behavioral performance record, the warning module to perform one of the first action where the warning module does not issue any immediate warning output, and the second action which is executed in a manner where the warning module outputs the diminished warning that serves as the immediate warning output.

3. The personalized driving early warning method as claimed in claim 2, wherein, in sub-step D-2):
when the number of instances of positive performance is not smaller than a predetermined number, the processing module controls the warning module to perform the first action; and
when the number of instances of positive performance is smaller than the predetermined number, the processing module controls the warning module to perform the second action in the manner where the warning module outputs the diminished warning that serves as the immediate warning output.

4. The personalized driving early warning method as claimed in claim 2, further comprising a step of
E) by the processing module, when the behavior determination module fails to identify any of the facial expression feature and the behavioral feature of the driver in step B), controlling the warning module to output the standard warning.

5. The personalized driving early warning method as claimed in claim 4, wherein the enhanced warning is one of a highest level warning and a second-highest level warning, where the highest level warning has a warning effect stronger than a warning effect of the second-highest level warning;
wherein, in sub-step D-1):
when the predefined negative behavior is categorized as a predefined high-risk negative behavior, the processing module controls the warning module to output the highest level warning that serves as the immediate warning output; and
when the predefined negative behavior is categorized as a predefined low-risk negative behavior, the processing module controls the warning module to output the second-highest level warning that serves as the immediate warning output.

6. The personalized driving early warning method as claimed in claim 5, further comprising, after the warning module issues the immediate warning output in step D), a step of:
F) by the processing module, determining whether the issuance of the immediate warning output was necessary for the driver based on post-event state of motion of the vehicle after the issuance of the immediate warning output, and updating the historical behavioral performance record based on the determination on whether the issuance of the immediate warning output was necessary for the driver.

7. The personalized driving early warning method as claimed in claim 6, wherein the historical behavioral performance record further records a number of instances of negative performance by the driver when the driver encountered the specific dangerous event in the past; and
wherein the state of motion of the vehicle when the specific dangerous event was detected serves as a reference state of motion of the vehicle, and step F) includes sub-steps of:
F-1) by the processing module, upon determining that the post-event state of motion of the vehicle has a variation that is greater than a predetermined level relative to the reference state of motion of the vehicle, determining that the issuance of the immediate warning output was necessary for the driver, and adding one to the number of instances of negative performance; and
F-2) by the processing module, upon determining that the post-event state of motion of the vehicle has a variation that is not greater than the predetermined level relative to the reference state of motion of the vehicle, determining that the issuance of the immediate warning output was unnecessary for the driver, and adding one to the number of instances of positive performance.

8. The personalized driving early warning method as claimed in claim 1, further comprising, after the processing module controls the warning module to perform the first action where the warning module does not issue any immediate warning output in step D), a step of:
E) by the processing module, determining whether the performing of the first action was appropriate for the driver based on post-event state of motion of the vehicle that occurs after step C), and updating the historical behavioral performance record based on the determination on whether the performing of the first action was appropriate for the driver.

9. The personalized driving early warning method as claimed in claim 8, wherein the historical behavioral performance record further records a number of instances of negative performance by the driver when the driver encountered the specific dangerous event in the past;
wherein the state of motion of the vehicle when the specific dangerous event was detected serves as a reference state of motion of the vehicle, and step E) includes sub-steps of:
E-1) by the processing module, upon determining that the post-event state of motion of the vehicle has a variation that is greater than a predetermined level relative to the reference state of motion of the vehicle, determining that the performing of the first action was inappropriate for the driver, and adding one to the number of instances of negative performance; and
E-2) by the processing module, upon determining that the post-event state of motion of the vehicle has a variation that is not greater than the predetermined level relative to the reference state of motion of the vehicle, determining that the performing of the first action was appropriate for the driver, and adding one to the number of instances of positive performance.

10. The personalized driving early warning method as claimed in claim 1, wherein step B) includes sub-steps of:
identifying the facial expression feature of the driver based on the in-vehicle driver monitoring footage immediately after the event detection module has detected that there is currently the specific dangerous event in the state of motion of the vehicle; and
following the identifying of the facial expression feature of the driver, identifying the behavioral feature of the driver based on the in-vehicle driver monitoring footage.

11. A personalized driving early warning system to be installed in a vehicle for use with an event data recorder and a driver monitoring recorder, comprising:
a storage module that stores a historical behavioral performance record of a driver of the vehicle;
an event detection module that is configured to determine, based on a driving footage captured by the event data recorder, whether there is currently a specific dangerous event in a state of motion of the vehicle, and to generate an event notification upon determining that there is currently the specific dangerous event in the state of motion of the vehicle;
a behavior determination module that is coupled to said event detection module for receiving the event notification, that is configured to, in response to the event notification, identify one of a facial expression feature and a behavioral feature of the driver based on an in-vehicle driver monitoring footage captured by the driver monitoring recorder, and that is further configured to, after obtaining a behavior identification result by successfully identifying said one of the facial expression feature and the behavioral feature of the driver, determine whether the behavior identification result conforms to a predefined positive behavior or a predefined negative behavior in terms of driving safety, so as to obtain a behavior determination result;
a warning module that is operable to issue an immediate warning output in one of multiple manners that correspond to different levels of warning effects, respectively; and
a processing module that is electrically connected to said storage module, said event detection module, said behavior determination module and said warning module, and that is configured to control operation of said warning module based on the behavior determination result and the historical behavioral performance record to make said warning module perform one of a first action and a second action that is aligned with an up-to-date behavior pattern of the driver, where the first action is that said warning module does not issue any immediate warning output, and the second action is that said warning module issues the immediate warning output to notify the driver of the specific dangerous event.

12. The personalized driving early warning system as claimed in claim 11, wherein the historical behavioral performance record records a number of instances of positive performance by the driver when the driver encountered the specific dangerous event in the past;
wherein the immediate warning output is in one of a plurality of predefined warning types, and the predefined warning types include a standard warning, an enhanced warning that has a warning effect stronger than a warning effect of the standard warning, and a diminished warning that has a warning effect weaker than the warning effect of the standard warning;
wherein said processing module is configured to, when the behavior determination result indicates that the behavior identification result conforms to the predefined negative behavior, control said warning module to output the enhanced warning that serves as the immediate warning output; and
wherein said processing module is configured to, when the behavior determination result indicates that the behavior identification result conforms to the predefined positive behavior, control, based on the number of instances of positive performance as recorded in the historical behavioral performance record, said warning module to perform one of the first action where said warning module does not issue any immediate warning output, and the second action which is executed in a manner where said warning module outputs the diminished warning that serves as the immediate warning output.

13. The personalized driving early warning system as claimed in claim 12, wherein:
said processing module is configured to, when the behavior determination result indicates that the behavior identification result conforms to the predefined positive behavior and when the number of instances of positive performance is not smaller than a predetermined number, control said warning module to perform the first action; and
said processing module is configured to, when the behavior determination result indicates that the behavior identification result conforms to the predefined positive behavior and when the number of instances of positive performance is smaller than the predetermined number, control said warning module to perform the second action in the manner where said warning module outputs the diminished warning that serves as the immediate warning output.

14. The personalized driving early warning system as claimed in claim 12, wherein said behavior determination module is configured to, when failing to identify any of the facial expression feature and the behavioral feature of the driver, send an identification failure notification to said processing module; and
wherein said processing module is configured to control said warning module to output the standard warning in response to the identification failure notification.

15. The personalized driving early warning system as claimed in claim 14, wherein the enhanced warning is one of a highest level warning and a second-highest level warning, where the highest level warning has a warning effect stronger than a warning effect of the second-highest level warning;
wherein said processing module is configured to, when the behavior determination result indicates that the behavior identification result conforms to the predefined negative behavior and the predefined negative behavior is categorized as a predefined high-risk negative behavior, control said warning module to output the highest level warning that serves as the immediate warning output; and
wherein said processing module is configured to, when the behavior determination result indicates that the behavior identification result conforms to the predefined negative behavior and the predefined negative behavior is categorized as a predefined low-risk negative behavior, control said warning module to output the second-highest level warning that serves as the immediate warning output.

16. The personalized driving early warning system as claimed in claim 15, wherein said processing module is configured to, after said warning module issues the immediate warning output, determine whether the issuance of the immediate warning output was necessary for the driver in terms of ensuring driving safety based on post-event state of motion of the vehicle that occurs after the issuance of the immediate warning output, and updating the historical behavioral performance record based on the determination on whether the issuance of the immediate warning output was necessary for the driver.

17. The personalized driving early warning system as claimed in claim 16, wherein the historical behavioral performance record further records a number of instances of negative performance by the driver when the driver encountered the specific dangerous event in the past;
wherein the state of motion of the vehicle when the specific dangerous event was detected serves as a reference state of motion of the vehicle;
wherein said processing module is configured to, upon determining that the post-event state of motion of the vehicle shows a variation that is greater than a predetermined level relative to the reference state of motion of the vehicle, determine that the issuance of the immediate warning output was necessary for the driver, and add one to the number of instances of negative performance; and
wherein said processing module is configured to, upon determining that the post-event state of motion of the vehicle shows a variation that is not greater than the predetermined level relative to the reference state of motion of the vehicle, determine that the issuance of the immediate warning output was not necessary for the driver, and add one to the number of instances of positive performance.

18. The personalized driving early warning system as claimed in claim 11, wherein said processing module is configured to, after controlling said warning module to perform the first action where said warning module does not issue any immediate warning output, determine whether the performing of the first action was appropriate for the driver based on post-event state of motion of the vehicle that occurs after the performing of the first action, and to update the historical behavioral performance record based on the determination on whether the performing of the first action was appropriate for the driver.

19. The personalized driving early warning system as claimed in claim 18, wherein the historical behavioral performance record further records a number of instances of negative performance by the driver when the driver encountered the specific dangerous event in the past;
wherein the state of motion of the vehicle when the specific dangerous event was detected serves as a reference state of motion of the vehicle;
wherein said processing module is configured to, upon determining that the post-event state of motion of the vehicle shows a variation that is greater than a predetermined level relative to the reference state of motion of the vehicle, determine that the performing of the first action was inappropriate for the driver, and add one to the number of instances of negative performance; and
wherein said processing module is configured to, upon determining that the post-event state of motion of the vehicle shows a variation that is not greater than the predetermined level relative to the reference state of motion of the vehicle, determine that the performing of the first action was appropriate for the driver, and add one to the number of instances of positive performance.

20. The personalized driving early warning system as claimed in claim 11, wherein said behavior determination module is configured to, in response to the event notification, immediately identify the facial expression feature of the driver based on an in-vehicle driver monitoring footage, and to, following the identifying of the facial expression feature of the driver, identify the behavioral feature of the driver based on the in-vehicle driver monitoring footage.
